(19) United States
(12) Patent Application Publication
(10) Pub. No.: US 2026/0268766 A1
(43) Pub. Date: Sep. 10, 2026

(54) SYSTEMS AND METHODS FOR GUIDING DRIVER BEHAVIOR BASED ON AN IDENTIFIED APPROACHING EMERGENCY VEHICLE

(71) Applicant: Toyota Motor Engineering & Manufacturing North America, Inc., Plano, TX (US)

(72) Inventors: Benjamin Piya Austin, Saline, MI (US); Jennifer J. Angel, Manchester, MI (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 19/074,162

(22) Filed: Mar. 7, 2025

(51) Int. Cl. G08G 1/0965; G08G 1/00; G08G 1/052; G08G 1/0967; H04W 4/40; H04W 4/90

(52) U.S. Cl. CPC G08G 1/0965; G08G 1/052; G08G 1/096725; G08G 1/22; H04W 4/40; H04W 4/90

(57) ABSTRACT

Methods, systems, and devices for guiding driver behavior based on an identified approaching emergency vehicle. The system may include one or more sensors configured to capture or receive data indicating that an emergency vehicle is approaching. The system may also include an electronic control unit (ECU) configured to (1) determine an emergency vehicle is approaching the vehicle based on data captured or received from the one or more sensors, (2) determine a destination of the emergency vehicle, (3) determine a proposed response to the emergency vehicle, and (4) transmit an alert to the vehicle, the alert indicating that the emergency vehicle is approaching, identifying the destination of the emergency vehicle, and detailing the proposed response to the approaching emergency vehicle.

### BACKGROUND

### 1. Field

The present disclosure relates to systems and methods for guiding driver behavior based on an identified approaching emergency vehicle.

### 2. Description of the Related Art

Current devices may include systems or methods for identifying an approaching emergency vehicle or guiding driver behavior based on the approaching emergency vehicle. Existing technologies for providing information to a driver regarding an emergency vehicle have included sending a signal with a visual and/or audio alert that is sent to vehicles in the vicinity of the emergency vehicle. For example, existing technologies may include an alert indicating an approaching emergency vehicle for nearby vehicles and directions for controlling the vehicle. However, the current technologies are generally not able to determine the type and destination of the emergency vehicle that is approaching, which may, for example, include the target of the emergency vehicle, particularly when the emergency vehicle is out of range of a particular vehicle.

Accordingly, it is desirable to provide improved methods, systems, and devices for identifying an approaching emergency vehicle and guiding the driver behavior based on the identified approaching emergency vehicle.

### SUMMARY

Described herein is a system for guiding driver behavior based on an identified approaching emergency vehicle. In one aspect, the system may include one or more sensors configured to capture or receive data indicating that an emergency vehicle is approaching. The system also may include an electronic control unit (ECU) in communication with a vehicle and the one or more sensors, and configured to (1) determine an emergency vehicle is approaching the vehicle based on data captured or received from the one or more sensors, (2) determine a destination of the emergency vehicle, (3) determine a proposed response to the emergency vehicle, and (4) transmit an alert to the vehicle, the alert indicating that the emergency vehicle is approaching, identifying the destination of the emergency vehicle, and detailing the proposed response to the approaching emergency vehicle.

In one aspect, the subject matter may be embodied in a method for guiding driver behavior based on an identified approaching emergency vehicle. The method may include determining an emergency vehicle is approaching a vehicle based on data captured or received from one or more sensors, the one or more sensors configured to capture or receive data indicating that the emergency vehicle is approaching. The method may further include determining a destination of the emergency vehicle. The method may further include determining a proposed response to the emergency vehicle. The method may further include transmitting an alert to the vehicle, the alert indicating that the emergency vehicle is approaching, identifying the destination of the emergency vehicle, and detailing the proposed response to the approaching emergency vehicle.

In one aspect, the subject matter may be embodied in a vehicle including a system for guiding driver behavior based on an identified approaching emergency vehicle. The vehicle may include one or more sensors configured to capture or receive data indicating that an emergency vehicle is approaching the vehicle. The vehicle may further include an ECU in communication with the vehicle and the one or more sensors, and configured to (1) determine an emergency vehicle is approaching the vehicle based on data captured or received from the one or more sensors, (2) determine a destination of the emergency vehicle, (3) determine a proposed response to the emergency vehicle, and (4) transmit an alert to the vehicle, the alert indicating that the emergency vehicle is approaching, identifying the destination of the emergency vehicle, and detailing the proposed response to the approaching emergency vehicle.

### BRIEF DESCRIPTION OF THE DRAWINGS

Other systems, methods, features, and advantages of the present disclosure will be apparent to one skilled in the art upon examination of the following figures and detailed description. Component parts shown in the drawings are not necessarily to scale and may be exaggerated to better illustrate the important features of the present disclosure. In the drawings, like reference numerals designate like parts throughout the different views.

FIG. 1 is a block diagram illustrating a vehicle having a system for guiding driver behavior based on an identified approaching emergency vehicle according to an aspect of the disclosure.

FIG. 2 is an example illustration of vehicles in operation along a road implementing the system for guiding driver behavior based on an identified approaching emergency vehicle according to an aspect of the disclosure.

FIG. 3 is a view of an example interior of a vehicle including the system for guiding driver behavior based on an identified approaching emergency vehicle according to an aspect of the disclosure.

FIG. 4 is a flowchart illustrating a method for guiding driver behavior based on an identified approaching emergency vehicle according to an aspect of the disclosure.

### DETAILED DESCRIPTION

Disclosed herein are methods, systems, devices, and/or vehicles for guiding driver behavior based on an identified approaching emergency vehicle. In general, one aspect of the subject matter described in this disclosure may be embodied in a driver guiding system for an approaching emergency vehicle. The driver guiding system can first identify and immediately inform drivers what type of emergency vehicle is or was in the vicinity, even before the driver may see or hear it approaching. The driver guiding system can further determine and inform drivers whether or not the driver is the target of the emergency vehicle (e.g., a police vehicle is planning to pull them over). The driver guiding system can also inform drivers how they should guide their vehicle in response to the approaching emergency vehicle, such as by pulling over or switching lanes.

Particular aspects or embodiments of the subject matter described in this disclosure may be implemented to realize one or more of the following advantages. Emergency vehicles can be in pursuit for several reasons, including but not limited to, pulling over a vehicle that has committed a violation (e.g., a police vehicle that is pursuing a driver who was speeding, made an improper lane change, etc.) or heading towards a destination quickly (e.g., an ambulance or fire truck that is heading towards an accident scene, crime scene, hospital, etc.). In these cases, the emergency vehicle will usually turn on its sirens and lights and head towards their target quickly. However, when a driver hears or sees sirens and/or lights behind them, they do not know (1) whether it is an ambulance, fire truck, police, or other emergency vehicle, (2) if they are the target if it is a police vehicle, and (3) how they need to guide their vehicle in response to the approaching emergency vehicle. As such, oftentimes when drivers hear and/or see sirens and/or lights behind them, they react by immediately slowing down and tend to look around for the source of the sound or siren lights and often move their eyes immediately to the various vehicle mirrors or directly to their speedometer to check their speed. These actions take the driver's eyes off the road in front of them and may increase chances of a road incident.

The driver guiding system can enable a driver to be informed about the nature of the approaching emergency vehicle and what actions the driver should take in response. This can improve safety of driving and decrease the likelihood of a road incident by keeping the driver's eyes on the road instead of looking around for the emergency vehicle or at their speedometer. In addition, the driver guiding system may also help to reduce traffic on roadways as the driver guiding system can prevent a driver from slamming on their breaks or otherwise unnecessarily slowing down in response to an approaching emergency vehicle, which can cause traffic delays. The driver guiding system can also enable emergency vehicles to reach their target destination faster, which is especially important for time-critical, life-threatening situations, by allowing the non-emergency vehicles ahead of them to promptly make way for the emergency vehicle.

An exemplary system for guiding driver behavior based on an identified approaching emergency vehicle is disclosed herein. The system may include one or more sensors configured to capture or receive data indicating that an emergency vehicle is approaching. The system may also include an electronic control unit (ECU) configured to (1) determine an emergency vehicle is approaching the vehicle based on data captured or received from the one or more sensors, (2) determine a destination of the emergency vehicle, (3) determine a proposed response to the emergency vehicle, and (4) transmit an alert to the vehicle, the alert indicating that the emergency vehicle is approaching, identifying the destination of the emergency vehicle, and detailing the proposed response to the approaching emergency vehicle.

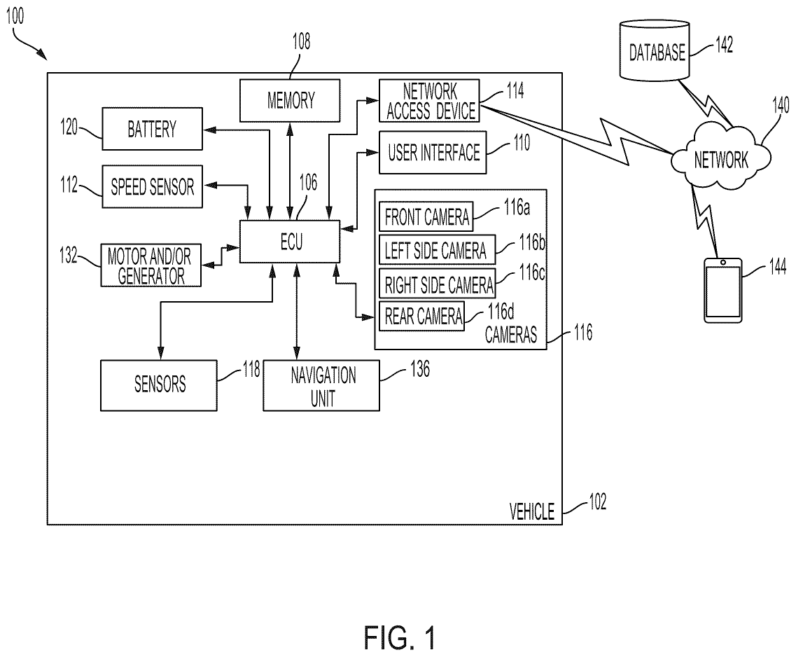

FIG. 1 is a block diagram for an example driver guiding system 100. The driver guiding system 100 or a portion thereof may be retrofitted, coupled to, include, or be included within a vehicle 102 or separate from the vehicle 102. The vehicle 102 may be a conveyance capable of transporting a person, an object, or a permanently or temporarily affixed apparatus. The vehicle 102 may be a self-propelled wheeled conveyance, such as a car, a sports utility vehicle, a truck, a bus, a van, a motorcycle, or other motor, battery, or fuel cell driven vehicle. For example, the vehicle 102 may be an electric vehicle, a hybrid vehicle, a plug-in hybrid vehicle, a hydrogen fuel cell vehicle, or any other type of vehicle that has a fuel cell, a motor, an engine, and/or a generator. Other examples of vehicles include bicycles, trains, planes, or boats, and any other form of conveyance that is capable of transportation. The vehicle 102 may be semi-autonomous or autonomous. That is, the vehicle 102 may be self-maneuvering and navigate without human input. An autonomous vehicle may have and use one or more sensors and/or a navigation unit to drive autonomously.

The driver guiding system 100 and/or the vehicle 102 may include a motor and/or generator 132 and/or a battery 120. The motor and/or generator 132 may be located within an engine bay of the vehicle 102. For example, the motor and/or generator 132 may be an internal combustion engine (ICE). In this regard, the motor and/or generator 132 may combust an air and fuel mixture to provide power to the vehicle 102 and/or components of the vehicle 102 and/or the driver guiding system 100. Accordingly, the motor and/or generator 132 can cause the vehicle 102 to accelerate, decelerate, or maintain a desired velocity. The motor and/or generator 132 may include combinations of an ICE and an electric motor, such as for hybrid electric vehicle (HEV) applications, for example. In examples, the motor and/or generator 132 may be an electric motor, such as for battery electric vehicle (BEV) applications, for example. In this regard, the motor and/or generator 132 may be an electric motor and an electric generator that converts electrical energy into mechanical power, such as torque, and converts mechanical power into electrical energy. The motor and/or generator 132 may be electrically connected to the battery 120. The motor and/or generator 132 may convert energy from the battery 120 into mechanical power, and may provide energy back to the battery 120, for example, via regenerative braking. The battery 120 may be electrically connected to the motor and/or generator 132 and may provide electrical energy to and/or receive electrical energy from the motor and/or generator 132. The battery 120 may provide electrical energy to the driver guiding system 100.

The driver guiding system 100 and/or the vehicle 102 may further include one or more processors, such as an electronic control unit (ECU) 106. The ECU 106 may be implemented as a single ECU or in multiple ECUs. The ECU 106 may be electrically connected to some or all of the components of the vehicle 102 and/or the driver guiding system 100 (e.g., via a controller area network (CAN) bus and/or other protocols). For example, the ECU 106 may be electrically connected to the motor and/or generator 132, the battery 120, a memory 108, a user interface 110, a network access device 114, a navigation unit 136, a speed sensor 112, one or more cameras 116, and/or one or more sensors 118. The ECU 106 may include one or more processors (or controllers) specifically designed for controlling operations of the vehicle 102, such as accelerating, braking, autonomous driving, parking (or parking assistance), etc. Moreover, the ECU 106 may control a panoramic view monitor (PVM) of the vehicle 102 (e.g., including the user interface 110, the one or more cameras 116, and/or the one or more sensors 118). In examples, the ECU 106 may be and/or include an advanced driver assistance systems (ADAS) sensor fusion ECU, a PVM ECU, an engine control module (ECM), a transmission control module (TCM), a telematics control unit (TCU), an inertial measurement unit (IMU), an in-vehicle infotainment (IVI) ECU, and/or a graphics processing unit (GPU).

The driver guiding system 100 may further include the memory 108. The memory 108 may be electrically connected to the ECU 106. In examples, the memory 108 may be communicatively coupled (e.g., via a network 140 and/or the network access device 114) to the ECU 106 such that the memory 108 is remote from the ECU 106 and/or the vehicle 102. In other examples, the memory 108 may be electrically connected to the ECU 106 and a remote memory (e.g., a remote database 142) may be communicatively coupled to the ECU 106, with the remote memory having similar, additional, and/or different functions as the memory 108 (e.g., greater storage capacity, enabling over-the-air updates, etc.). The memory 108 may store instructions to execute on the ECU 106 and may include one or more of a random access memory (RAM) or other volatile or non-volatile memory. The memory 108 may be a non-transitory memory or a data storage device, such as a hard disk drive, a solid-state disk drive, a hybrid disk drive, or other appropriate data storage, and may further store machine-readable instructions, which may be loaded and executed by the ECU 106. The memory 108 may store vehicle parameters (e.g., a type of the vehicle 102, a weight of the vehicle 102, dimensions of the vehicle 102, transmission gear information of the vehicle 102, etc.).

The driver guiding system 100 may further include the user interface 110. The user interface 110 may be located within a cabin of the vehicle 102 (e.g., coupled to a dashboard of the vehicle 102). The user interface 110 may provide an interface to a user of the vehicle 102 (e.g., a driver and/or a passenger of the vehicle 102) to interact with and/or receive output from the ECU 106. The user interface 110 may have a user interface element, such as a screen and/or a touchscreen with a button, a switch, a microphone, a speaker, a gesture monitoring sensor, a knob, a graphical user interface (GUI), and/or other input/output devices electrically connected to the ECU 106 to provide input and/or output of information (or data) to and/or from the ECU 106.

The driver guiding system 100 may further include the network access device 114. The network access device 114 may be electrically connected to the ECU 106 and may include a communication port or channel, such as one or more of a Wi-Fi unit, a Bluetooth® unit, a Radio Frequency Identification (RFID) tag or reader, a Dedicated Short Range Communications (DSRC) unit, a satellite network unit, and/or a cellular network unit for accessing the network 140 (e.g., CDMA, GSM, 3G, 4G, 5G, etc.). The network access device 114 may transmit data to and receive data from devices and systems not directly connected to the vehicle 102. For example, the ECU 106 may communicate with the remote database 142, a user device 144 (e.g., a mobile device, a phone, a tablet, a laptop, a vehicle, etc.), other vehicles, and/or emergency services through the network access device 114.

The network access device 114 may transmit data to and receive data from other databases 142, for example using vehicle-to-vehicle (V2V), vehicle-to-everything (V2X), and/or vehicle-to-infrastructure (V2I) communication. For example, driver guiding system 100 can enable vehicle 102 to exchange vehicle data with a second vehicle using V2V communication technology. The driver guiding system 100 can receive location data such as traffic congestion, weather advisories, bridge clearance levels, traffic light status, and/or crime data to inform the driver guiding system 100 of conditions at or near the location of the vehicle 102 or a location where the vehicle 102 is headed using V2I and/or V2X communication technology. Accordingly, the vehicle 102 may communicate with another vehicle or a network using vehicle-to-vehicle communications or vehicle-to-infrastructure communications via the network access device 114.

The driver guiding system 100 may further include the navigation unit 136. The navigation unit 136 may be electrically connected to the ECU 106 and may provide vehicle information (or data) and/or navigational map information to the ECU 106. The navigation unit 136 may include and/or be connected to a Global Positioning System (GPS) device. The vehicle information may include a current position and/or location of the vehicle 102, a current time at the current position, a direction of travel, and/or a current speed of the vehicle 102. In examples, the navigation unit 136 may provide the vehicle information (e.g., indicating the current speed of the vehicle 102) to the ECU 106. The ECU 106 and/or the navigation unit 136 may determine the current speed of the vehicle 102 (e.g., in miles per hour (MPH) and/or kilometers per hour (KPH)) based on the vehicle information.

The driver guiding system 100 may further include the speed sensor 112. In examples, the driver guiding system 100 may include a plurality of speed sensors. The speed sensor 112 may be electrically connected to the ECU 106. The speed sensor 112 may be configured to measure, detect, and/or determine the current speed of the vehicle 102. For example, the speed sensor 112 may be and/or include an electronic vehicle speed sensor (e.g., that measures rotation of the motor and/or generator 132 and/or a transmission shaft of the vehicle 102) and/or one or more wheel speed sensors (e.g., that measure rotation of one or more wheels of the vehicle 102). In examples, the speed sensor 112 may provide speed data indicating the current speed of the vehicle 102 to the ECU 106. The ECU 106 and/or the speed sensor 112 may determine the current speed of the vehicle 102 (e.g., in miles per hour (MPH) and/or kilometers per hour (KPH)) based on the speed data.

The driver guiding system 100 may further include the one or more cameras 116. The one or more cameras 116 may be coupled to an exterior of the vehicle 102 and/or an interior of the vehicle 102 such that the one or more cameras 116 look out toward a surrounding area of the vehicle 102. The one or more cameras 116 may be and/or include one or more of an analog camera, a digital camera, a thermal camera, and/or a night vision camera (e.g., utilizing active illumination and/or image intensification). The one or more cameras 116 may provide, capture, and/or record images and/or real-time video of the surrounding area of the vehicle 102. In examples, the one or more cameras 116 (e.g., via the ECU 106) may also have pattern recognition capabilities to view the surrounding area and identify, for example, vehicles, components of vehicles (e.g., a license plate, a side view mirror, etc.), road signs (e.g., speed limit signs), and/or writing (e.g., letters, numbers, symbols, etc.) on the vehicles and/or the road signs. The one or more cameras 116 may include one or more front cameras 116a, one or more left side cameras 116b, one or more right side cameras 116c, and/or one or more rear cameras 116d.

The one or more front cameras 116a may be coupled to a front end of the vehicle 102, such as a front bumper and/or a windshield, for example. In examples, the one or more front cameras 116a may include a plurality of front cameras (e.g., with each having a different field of view, orientation, and/or location on the vehicle 102). The one or more front cameras 116a may provide, capture, and/or record real-time video of a forward field of view with respect to the vehicle 102 (e.g., a portion of the surrounding area of the vehicle 102 that is in front of the vehicle 102).

The one or more left side cameras 116b may be coupled to a left side of the vehicle 102, such as a left side mirror, a left front quarter panel (or fender), a left rear quarter panel (or fender), a left side door, etc. In examples, the one or more left side cameras 116b may include a plurality of left side cameras (e.g., with each having a different field of view, orientation, and/or location on the vehicle 102). The one or more left side cameras 116b may provide, capture, and/or record real-time video of a leftward field of view with respect to the vehicle 102 (e.g., a portion of the surrounding area of the vehicle 102 that is to the left of the vehicle 102).

The one or more right side cameras 116c may be coupled to a right side of the vehicle, such as a right side mirror, a right front quarter panel (or fender), a right rear quarter panel (or fender), a right side door, etc. In examples, the one or more right side cameras 116c may include a plurality of right side cameras (e.g., with each having a different field of view, orientation, and/or location on the vehicle 102). The one or more right side cameras 116c may provide, capture, and/or record real-time video of a rightward field of view with respect to the vehicle 102 (e.g., a portion of the surrounding area of the vehicle 102 that is to the right of the vehicle 102).

The one or more rear cameras 116d may be coupled to a rear end of the vehicle 102, such as a rear bumper, a rear window, a tailgate, and/or a liftgate, for example. In examples, the one or more rear cameras 116d may include a plurality of rear cameras (e.g., with each having a different field of view, orientation, and/or location on the vehicle 102). The one or more rear cameras 116d may provide, capture, and/or record real-time video of a rearward field of view with respect to the vehicle 102 (e.g., a portion of the surrounding area of the vehicle 102 that is behind the vehicle 102).

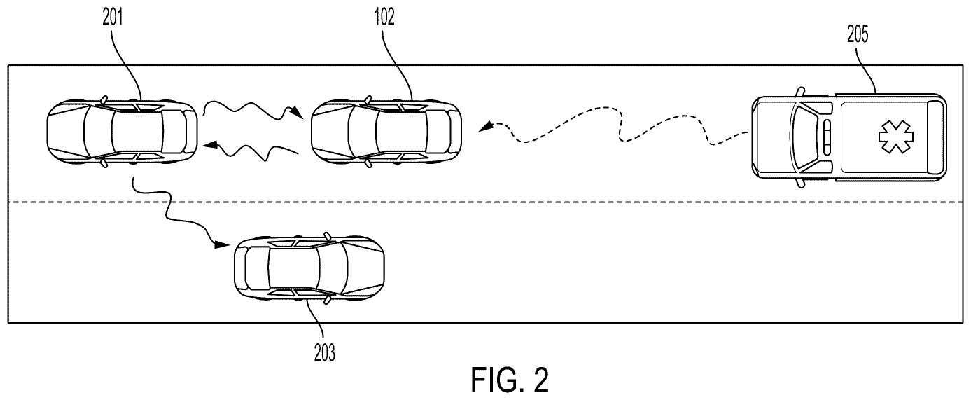

The driver guiding system 100 may further include the one or more sensors 118. The one or more sensors 118 may be and/or include one or more of a camera, a radar sensor, an ultrasonic sensor, a lidar sensor, a brake pedal sensor, an accelerator pedal sensor, a GPS, a radio frequency (RF) sensor, or any other suitable device. The one or more sensors 118 may measure, detect, receive, and/or determine information (or data) of the vehicle 102, the one or more passenger vehicles 201 and 203, and/or an emergency vehicle 205 (marked in FIG. 2). For example, the one or more sensors 118 may periodically or continuously scan (or monitor) the surrounding area of the vehicle 102 to measure, detect, and/or determine spatial information. The spatial information may be radar data, lidar data, ultrasonic data, and/or image (or video) data, for example. The spatial information may include and/or indicate a position, a direction, and/or a velocity of the one or more passenger vehicles 201 and 203 and/or the emergency vehicle 205 relative to the vehicle 102 at one or more points in time and/or over one or more periods of time. A location of each of the one or more sensors 118 on the vehicle 102 may be known to the ECU 106 (e.g., the location of each of the one or more sensors 118 may be stored on the memory 108).

In examples where the one or more sensors 118 include one or more cameras (e.g., the one or more cameras 116), the driver guiding system 100 may use monocular and/or binocular depth estimation on image (or video) data captured or recorded by the one or more sensors 118 to determine the spatial information.

The one or more sensors 118 may further collect data related to the vehicle 102 and any passengers inside the vehicle. For example, the one or more sensors 118 may collect images from inside the vehicle or seat sensor data that may indicate the number of passengers inside the vehicle. As another example, a GPS sensor may indicate the location of the vehicle.

FIG. 2 is an illustration of vehicles in operation along a road that may incorporate the example driver guiding system 100 of FIG. 1. The driver guiding system 100 may include a vehicle 102 and one or more passenger vehicles 201 and 203 and an emergency vehicle 205. While the examples of vehicles in this disclosure may relate to ground vehicles, any type of vehicles capable of moving along the land, sea, air, or space can be used (e.g., a car, bus, truck, motorcycle, ship, boat, yacht, aircraft, unmanned aerial vehicle, urban air mobility vehicle).

The driver guiding system 100 may first detect that the emergency vehicle 205 is approaching. In one aspect, the emergency vehicle 205 may send a message or signal to the vehicle 102 (or to the one or more passenger vehicles 201 and 203) indicating that it is approaching. For example, the emergency vehicle 205 may send a message via a V2X signal. In another aspect, the vehicle 102 (or the one or more passenger vehicles 201 and 203) may identify that the emergency vehicle 205 is approaching using its sensors 118 and/or cameras 116. For example, the vehicle 102 may detect the approaching emergency vehicle 205 via the rear camera 116d that may show the emergency vehicle 205 approaching and/or via a microphone that can detect the sound of the emergency vehicle 205 siren. As an example, the sensors 118 and/or cameras 116 can detect and/or identify the approaching emergency vehicle 205 by reading or identifying an ambulance or police label or the color of the lights (e.g., red is an ambulance and blue is a police) of the vehicle 102. Once the driver guiding system 100 determines there is an emergency vehicle approaching and what it is, it can send a message to the vehicle 102 and/or the one or more passenger vehicles 201 and/or 203 that the emergency vehicle 205 is approaching.

An emergency vehicle approaching message can be generated at the vehicle 102 (e.g., via the ECU 106) and delivered from the vehicle 102 to the one or more passenger vehicles 201 or 203 using various connectivity modes. The various connectivity modes may include TN Connectivity (e.g., Cellular Networks), NTN Connectivity (e.g., Satellite), or V2X Connectivity. TN may include cellular networks, such as LTE, 3G, 4G, and 5G. TN may use radio waves to send and receive data between terrestrial or Earth-based transmitters and receivers. In one aspect, the vehicle 102 and the one or more passenger vehicles 201 or 203 may communicate via radio signals that can send a message to the other vehicles that the emergency vehicle 205 is approaching.

NTN connectivity may a use satellites to provide internet access. By using satellites, NTNs can extend network coverage beyond the ground-based cell towers and help to enable connectivity in remote areas where TNs are unavailable. While the examples of NTN in this disclosure relate to satellite systems, any NTN system can be used for the driver guiding system 100 described herein (e.g., Low Earth Orbit (LEO) satellites, Medium Earth Orbit (MEO) satellites, Geostationary Equatorial Orbit (GEO) satellites, High Altitude Platforms Station (HAPS), Uncrewed Aerial Vehicles (UAV)).

V2X may be a wireless communication technology that can enable a vehicle to exchange data with other vehicles or devices. V2X can enable direct communication between vehicles and other entities inside and outside the network coverage and has the potential to enable relaying messages through nearby vehicles to and from emergency vehicles. The methods and systems in this disclosure can be applied to any TN/NTN/V2X communication systems, for example, existing 3GPP radio access technologies (e.g., LTE, 3G, 4G, 5G technologies, future 3GPP radio technologies such as 6G, and future Institute of Electrical and Electronics Engineers (IEEE) 802.11 family technologies).

The vehicle 102 and the one or more passenger vehicles 201 or 203 may communicate with each other via V2X communication. Therefore, when the vehicle 102 or the one or more passenger vehicles 201 or 203 detects that the emergency vehicle 205 is approaching, it can relay a signal via V2X communication to the other vehicles indicating that the emergency vehicle 205 is approaching. The V2X signal can also send a digital auditory alert to all vehicles in the vicinity.

In one aspect, the driver guiding system 100 may determine a position, a direction, and/or a velocity of the emergency vehicle 205 relative to the vehicle 102 at one or more points in time and/or over one or more periods of time using spatial information. The driver guiding system 100 may include the position, direction, and/or velocity of the emergency vehicle 205 relative to the vehicle 102 in the signal or alert relayed to the vehicle 102 and/or surrounding vehicles.

In one aspect, the driver guiding system 100 may identify nearby vehicles to send the emergency vehicle approaching message using spatial information. For example, as the vehicle 102 passes the other passenger vehicles, spatial information may indicate when the other passenger vehicles have entered a sensor detection zone. The ECU 106 may determine when the other passenger vehicles entered the sensor detection zones based on the spatial information (e.g., radar data, lidar data, ultrasonic data, and/or image (or video) data) received from the one or more sensors 118.

Moreover, in examples, the one or more sensors 118 may determine a distance between the vehicle 102 and the one or more passenger vehicles 201 and 203 at each instance of the one or more passenger vehicles 201 and 203 entering the sensor detection zone. This may be used by the ECU 106 to determine a distance traveled by the one or more passenger vehicles 201 and 203 within the determined one or more periods of time. The ECU 106 may then determine the one or more passenger vehicles 201 and 203 are within range to send the message.

In examples, the one or more sensors 118 may be configured to determine, detect, and/or measure spatial information of the one or more passenger vehicles 201 and 203 as the one or more passenger vehicles 201 and 203 approach the vehicle 102 from behind. The ECU 106 may be configured to determine the one or more passenger vehicles 201 and 203 are within range to relay a message based on a period of time between the one or more passenger vehicles 201 and 203 being a first distance from the vehicle 102 (e.g., 50 feet, 100 feet, etc.) and the one or more passenger vehicles 201 and 203 being a second distance from the vehicle 102 (e.g., 5 feet, 10 feet, etc.), for example. Accordingly, the ECU 106 may be configured to determine the one or more passenger vehicles 201 and 203 are within range as the one or passenger vehicles 201 and 203 approach the vehicle 102 (e.g., when the one or more passenger vehicles 201 and 203 are in the same lane as the vehicle 102 or a lane adjacent to a current lane of the vehicle 102) and/or pass the vehicle 102 (e.g., when the one or more passenger vehicles 201 and 203 are in one or more lanes adjacent to a current lane of the vehicle 102).

In another aspect, the vehicle 102 may communicate to the other non-emergency vehicles that it has determined the emergency vehicle 205 is approaching by using its vehicle lights. The vehicle 102 may illuminate the external of the vehicle 102 to indicate the emergency vehicle 205 is approaching. For example, the vehicle 102 may use a light bar signaling the approach of the emergency vehicle 205 that goes around the vehicle 102 that is visible to the surrounding vehicles on the roadway.

The driver guiding system 100 may further identify the type of emergency vehicle approaching and whether the vehicle 102 is the target of the emergency vehicle (e.g., approaching police vehicle plans to pull over the vehicle 102). In one aspect, the emergency vehicle 205 may identify in the signal transmitted to the non-emergency vehicles what type of emergency vehicle is approaching and/or the target vehicle or destination of the emergency vehicle 205. The emergency vehicle 205 may also provide a description of the target vehicle. For example, a police vehicle may identify the vehicle it is pursuing by indicating a description of the vehicle (e.g. “I'm going after the red Corolla”) and/or collecting images of the vehicle or license plate and including this information in the transmitted signal.

In another aspect, the vehicle 102 may identify the type of emergency vehicle using its sensors 118 and/or cameras 116. For example, the cameras 116 may show that the approaching emergency vehicle is an ambulance, police vehicle, firetruck, hazmat, etc. The vehicle 102 may also determine a probability that it is the target vehicle using the speed sensor 112, sensors 118, and/or cameras 116. In one aspect, the speed sensor 112 may determine the current speed of the vehicle 102 and the cameras 116 may identify that the driver has committed a driving infraction. Based on the current speed of the vehicle 102 and any identified driving infractions, the driver guiding system 100 can approximate the chance that the vehicle 102 is the target of the emergency vehicle 205. As an example, the speed sensor 112 may detect that the vehicle 102 is driving 15 miles per hour over the speed limit and the cameras 116 may identify that the driver has committed a driving infraction. Based on this information, the driver guiding system 100 may estimate and alert the driver that there is a 90% chance that they are the target of the emergency vehicle 205.

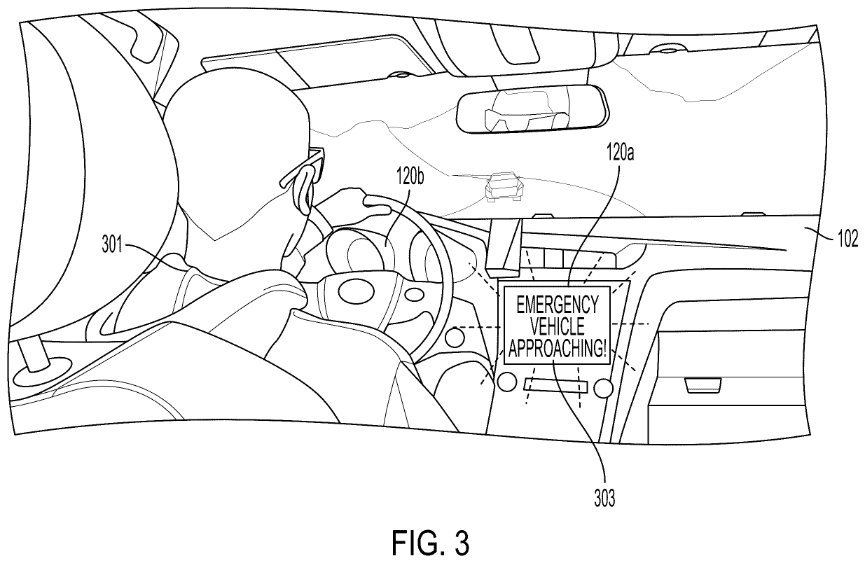

FIG. 3 is an example illustration of an interior of a vehicle 102 implementing the driver guiding system 100 based on an identified approaching emergency vehicle according to an aspect of the disclosure. The interior of the vehicle 102 may include a user interface (or infotainment display) 120a and/or a gauge cluster 120b. Within the interior of the vehicle 102 may be a driver 301, who is operating the vehicle 102. As described above with respect to FIG. 2, the driver guiding system 100 may determine that an emergency vehicle is approaching towards the vehicle 102. Once the driver guiding system 100 determines that an emergency vehicle is approaching, the driver guiding system 100 can alert the driver 301 and/or provide guidance for how to adjust driving based on the approaching emergency vehicle.

Once the driver guiding system 100 determines there is an emergency vehicle approaching, the driver guiding system 100 may send an alert 303 to the vehicle 102. The alert can be sent to screens (e.g., user interface (or infotainment display) 120a and/or gauge cluster 120b) within the vehicle. For example, as shown in FIG. 3, the driver guiding system 100 may send an alert 303 to the user interface 120a of the vehicle 102 stating “EMERGENCY VEHICLE APPROACHING!” The driver guiding system 100 may also send the alert to mobile devices, such as user device 144 of FIG. 1 (e.g., a mobile device, a phone, a tablet, a laptop, a vehicle, etc.) and other surrounding vehicles in the vicinity.

The alert can include information about the approaching emergency vehicle and provide guidance for the driver. The alert can be a visual alert or auditory alert. The information in the alert may include the number of emergency vehicles approaching, whether or not the driver is the target, directions for controlling the vehicle (e.g., pull off to the side and bring the vehicle to a stop), from which direction the emergency vehicle is approaching, as well as the distance, position, and/or velocity of the emergency vehicle. For example, the alert can include whether the vehicle is approaching from the opposite direction, and there is no action for the driver to take, that the driver is not the target of the emergency vehicle, and the driver need not take any action in response to the approaching emergency vehicle.

In one aspect, the driver guiding system 100 can send a V2X signal and/or visual or auditory alert to vehicles in the vicinity informing them on (a) what type of emergency vehicle was in the vicinity (even before the vehicles may see/hear it approaching), (b) whether the vehicles are the target, and (c) how the drivers of those vehicles should guide their vehicle. The visual alert can come through multimedia screen and/or phones and further include information on the direction from which the emergency is approaching. The visual alerts can be sent to back seat screens as well, as rear passengers need to become quickly aware of the situation so that can change their behavior (e.g., quiet down) if necessary, to allow the driver to better concentrate in the emergency situation.

The visual alert can also indicate if the emergency vehicle can be ignored. For example, the emergency vehicle can be ignored if the emergency vehicle is approaching from the opposing direction on a highway, but the highway is divided by a rail or median, and there is nothing that the driver can (or should) do.

An auditory alert can further come through the vehicle 102's speakers. For example, the auditory alert can project via the vehicle 102's speakers: (a) “Two ambulances are approaching from behind you,” (b) “You are not the target,” and (c) “Pull off on the right shoulder and bring your vehicle to a stop.” The alert may follow up after the emergency vehicle has passed with, for example, (d) “Both vehicles have passed you; it is safe to get back on the road.”

In another approach, the driver guiding system 100 may use nearby infrastructure to provide information to the vehicle 102. The infrastructure may be equipped with V2X technology so that it may communicate with the vehicle 102 and/or the driver guiding system 100. Infrastructure may include streetlights, light poles, road signs, cameras mounted onto stoplights, and any other objects along a roadway equipped with V2X technology. For example, streetlights can be used to illuminate the lane in which the emergency vehicle is approaching or to indicate the proximity of the emergency vehicle. In another example, light posts can shoot streams of water or lights/lasers onto the vehicle 102 to alert the driver of a nearby emergency vehicle.

In another aspect, the driver guiding system 100 may show, via the infrastructure, where the emergency vehicle is going to be travelling. The driver guiding system 100 may show this by using streetlights (with good spatial resolution) to illuminate the lane in which the emergency vehicle will be approaching. In some aspects, the driver guiding system 100 may change the color of street lights to indicate proximity of emergency vehicle (e.g., white lights indicate the emergency vehicle is three miles away, orange lights indicate the emergency vehicle is two miles away, and red lights indicate the emergency vehicle is one mile away) or flash the street lights based on how far away the emergency vehicle is (e.g., faster flashing rate indicates that the emergency vehicle is closer).

The driver guiding system 100 may further show who the target is by using the V2X enabled systems. For example, for a V2X enabled vehicle, the driver guiding system 100 can pulsate cabin lights of the target vehicle and/or cause the cabin lights in the target vehicle to turn on and off repeatedly. For a non-V2X enabled vehicle, the driver guiding system 100 may have water rifles (via V2X communication) shoot streams of water onto the target vehicle when passing in proximity to a water rifle. The water rifle may be mounted in the infrastructure, such as to V2X enabled light posts along the side of the road. In another aspect, the driver guiding system 100 may cause the police vehicle to shoot out a water stream onto the target vehicle using a long-range water rifle. Also, instead of water, the driver guiding system 100 may use paintballs, or an arc of light and/or a laser to identify the target vehicle. The paintballs may be water soluble to not cause damage to the target vehicle.

In one aspect, the driver guiding system 100 may use augmented reality (AR) to prevent a driver from seeing and being distracted by emergency vehicle. The driver guiding system 100 can determine if there is an emergency vehicle is in the vicinity and whether the path or future path of that emergency vehicle may have any effect (or residual effects) on a driver and how they may maneuver their vehicle. If it is determined that the emergency vehicle will not have an effect on the driver or their vehicle, then the driver guiding system 100 can prevent the emergency vehicle from being seen or heard by the driver using AR. AR glass can be used to remove the emergency vehicle and/or disrupted traffic patterns of other vehicles from the field-of-view of the driver, and sound canceling techniques can be used to cancel the sound of sirens. This may prevent the driver from looking at the emergency vehicle and/or corresponding disrupted traffic patterns, which may unnecessarily distract the driver from the driving task and/or cause the driver to slowdown thereby creating an unnecessary traffic backup on the roadway.

The driver guiding system 100 may further respond to the approaching emergency vehicle by turning off vehicle radio, speakers, etc., and attenuating human speech sound levels within the cabin of a vehicle so that a driver can more clearly hear an oncoming emergency vehicle. Additionally, the driver guiding system 100 may turn off ADAS features so that they do not interfere with the driver pulling the vehicle over to make way for the emergency vehicle. In one aspect, in response to the approaching emergency vehicle, the vehicle 102 can platoon with surrounding vehicles and become operated by a single automated driving system to pull over to the side of the road in a coordinated manner to allow an emergency vehicle to pass.

The driver guiding system 100 may further include controlling non-emergency vehicles (NEVs) in the vicinity of an emergency vehicle to provide aid to the emergency vehicle in reaching its destination. Various examples of controlling the NEVs may include controlling one or more NEVs to: park over a pothole, ice patch, oil slick, or other hazard and flash its blinkers; park and air their exhaust toward an ice patch or snow to try to melt it; run over roadkill or debris to flatten it; push roadkill or debris to the side of the road; block crosswalks or perimeters of intersections to prevent pedestrians, bicyclists, other vehicles, etc. from entering the intersection; park and shine its headlights to illuminate hard-to-see areas; and/or line the outside shoulder of a curve so that if the emergency vehicle slides or tips over, the NEVs will knock the emergency vehicle back into the roadway.

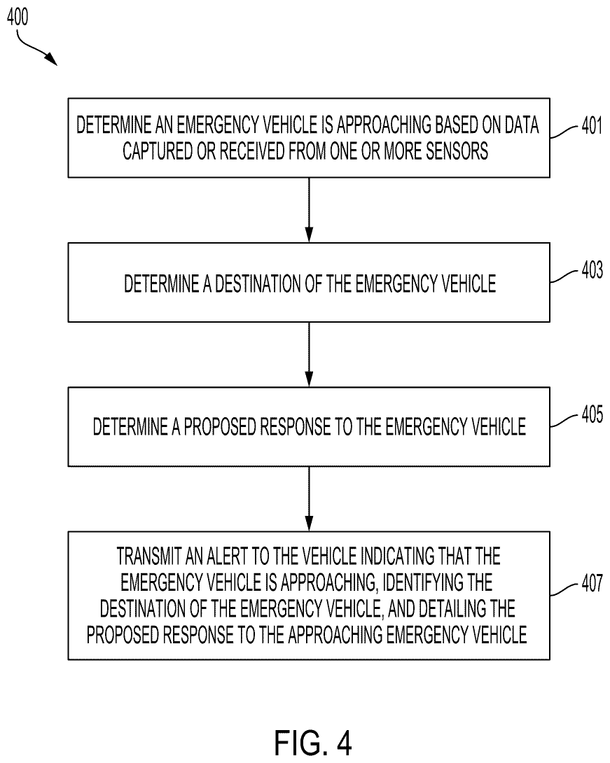

FIG. 4 is a flowchart illustrating a method 400 for guiding driver behavior based on an identified approaching emergency vehicle according to an aspect of the disclosure. One or more computers or one or more data processing apparatuses, for example, the ECU 106 of the driver guiding system 100 of FIG. 1, appropriately programmed, may implement the method 400. The method 400 of the disclosure, however, is not limited to use of the exemplary driver-relevant scene capturing systems of FIGS. 1-3.

The method 400 begins at block 401 where the driver guiding system 100 may determine an emergency vehicle is approaching based on data captured or received from one or more sensors. The one or more sensors may be and/or include one or more of a camera, a radar sensor, an ultrasonic sensor, a lidar sensor, a brake pedal sensor, an accelerator pedal sensor, a GPS, an RF sensor, or any other suitable device, such as the one or more sensors 118 of FIG. 1. The one or more sensors 118 may measure, detect, receive, and/or determine information (or data) of the vehicle 102 and/or an emergency vehicle. For example, a camera may detect that an emergency vehicle is approaching when the vehicle comes into view. In another aspect, the one or more sensors (e.g., the RF sensor) may receive a signal from the approaching emergency vehicle to let the vehicle 102 know that it is approaching. The signal may further include other information about the approaching emergency vehicle, such as type of emergency vehicle or target/destination of the emergency vehicle.

At block 403, the driver guiding system 100 may determine a destination of the emergency vehicle. The destination may be a target vehicle or other location, such as a hospital, police station, fire station, etc. The driver guiding system 100 may determine the destination of the emergency vehicle based on receiving a message or signal from the emergency vehicle. The message or signal from the emergency vehicle may indicate the target or destination of the emergency vehicle. The driver guiding system 100 may also determine the destination using the cameras 116 and/or one or more sensors 118.

At block 405, the driver guiding system 100 may determine a proposed response to the emergency vehicle. The driver guiding system 100 may determine a proposed response to the emergency vehicle based on the location of the emergency vehicle, the direction the emergency vehicle is travelling, the type of emergency vehicle, and/or the destination or target of the emergency vehicle. For example, if the emergency vehicle is an ambulance traveling in the same direction as the vehicle from behind, then the proposed response may be to pull over to the side of the road or navigate the vehicle to another lane. If the emergency vehicle is a police vehicle traveling behind the vehicle and the vehicle is the target vehicle, then the proposed response may be to navigate the vehicle to the side of the road and stop.

At block 407, the driver guiding system 100 may transmit an alert to the vehicle indicating that the emergency vehicle is approaching, identifying the destination of the emergency vehicle, and detailing the proposed response to the approaching emergency vehicle. The alert may be an audio or visual alert, such as a recorded audio message or alert displayed on a vehicle display. The driver guiding system 100 may transmit the alert to surrounding vehicles or nearby infrastructure, such as via V2X communication.

In the case of an autonomous vehicle, the driver guiding system 100 may further navigate the vehicle based on the proposed response from the alert. For example, the driver guiding system 100 may navigate the vehicle to the side of the road, navigate the vehicle to the side of the road and stop, or may navigate the vehicle to another lane based on the proposed response from the driver guiding system 100.

In one aspect, the driver guiding system 100 may estimate a probability that the vehicle is the target vehicle. In order to estimate the probability that the vehicle is the target vehicle, the driver guiding system 100 may determine a speed of the vehicle (e.g., via a vehicle speed sensor) and determine whether the driver has committed a driving infraction based on the data from the one or more sensors 118 or cameras 116. For example, the vehicle camera may detect in its image data that the driver has cut off another vehicle. Based on the recorded speed and whether or not the driver committed a driving infraction, the driver guiding system 100 may determine a probability that the vehicle is the target vehicle. For instance, if the driving is driving 20 miles per hour over the speed limit and has cut off another vehicle, as detected from the vehicle sensors or cameras, the driver guiding system 100 may estimate there is a 90% chance that the vehicle is the target vehicle. The driver guiding system 100 may thereafter transmit an alert to the vehicle indicating the probability that the vehicle is the target vehicle. For example, the vehicle may receive an auditory alert stating “You are above the speed limit. There is a 90% chance you are the target vehicle of the police car.”

Exemplary aspects or embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such aspects or embodiments that reasonably fall within the scope of the advancement to the art hereby contributed, and that that scope shall not be restricted, except in light of the appended claims and their equivalents.

What is claimed is:

1. A system for guiding driver behavior based on an identified approaching emergency vehicle, comprising:
one or more sensors configured to capture or receive data indicating that an emergency vehicle is approaching;
an electronic control unit (ECU) in communication with a vehicle and the one or more sensors, and configured to:
determine an emergency vehicle is approaching the vehicle based on data captured or received from the one or more sensors;
determine a destination of the emergency vehicle;
determine a proposed response to the emergency vehicle; and
transmit an alert to the vehicle, the alert indicating that the emergency vehicle is approaching, identifying the destination of the emergency vehicle, and detailing the proposed response to the approaching emergency vehicle.

2. The system of claim 1, wherein the one or more sensors comprise one or more of: a camera, a radar sensor, an ultrasonic sensor, a lidar sensor, a brake pedal sensor, an accelerator pedal sensor, a radio frequency sensor, or a global positioning system (GPS).

3. The system of claim 1, further comprising:
a speed sensor coupled to the vehicle configured to detect a current speed of the vehicle, wherein the ECU is further configured to:
determine a speed of the vehicle from the speed sensor;
determine the driver has committed a driving infraction based on data from the one or more sensors;
estimate, based on the speed and the driver has committed a driving infraction, a probability that the vehicle is the target vehicle of the emergency vehicle; and
transmit a target vehicle alert to the vehicle indicating the probability that the vehicle is the target vehicle.

4. The system of claim 3, wherein the ECU is further configured to navigate the vehicle based on the proposed response from the alert.

5. The system of claim 3, wherein to navigate the vehicle based on the proposed response, the ECU is further configured to navigate the vehicle to the side of the road, wherein the proposed response indicates to pull over to the side of the road.

6. The system of claim 3, wherein to navigate the vehicle based on the proposed response, the ECU is further configured to navigate the vehicle to the side of the road and stop, wherein the proposed response indicates to pull over and stop on the side of the road.

7. The system of claim 2, wherein to navigate the vehicle based on the proposed response, the ECU is further configured to navigate the vehicle to another lane, wherein the proposed response indicates to switch lanes.

8. The system of claim 1, wherein to determine a destination of the emergency vehicle, the ECU is further configured to:
receive a message from the emergency vehicle indicating the target or destination of the emergency vehicle; and
determine the destination of the emergency vehicle from the message.

9. The system of claim 1, wherein the alert is an audio alert or visual alert.

10. The system of claim 1, wherein the ECU is further configured to transmit the alert to neighboring vehicles.

11. The system of claim 1, wherein the alert is transmitted to neighboring vehicles via vehicle to everything (V2X) communication.

12. The system of claim 1, wherein the alert is transmitted to nearby infrastructure via vehicle to everything (V2X) communication.

13. A method for guiding driver behavior based on an identified approaching emergency vehicle, comprising:
determining an emergency vehicle is approaching a vehicle based on data captured or received from one or more sensors, the one or more sensors configured to capture or receive data indicating that the emergency vehicle is approaching;
determining a destination of the emergency vehicle;
determining a proposed response to the emergency vehicle; and
transmitting an alert to the vehicle, the alert indicating that the emergency vehicle is approaching, identifying the destination of the emergency vehicle, and detailing the proposed response to the approaching emergency vehicle.

14. The method of claim 13, further comprising navigating the vehicle based on the proposed response from the alert.

15. The method of claim 13, further comprising:
determining a speed of the vehicle from a vehicle speed sensor;
determining the driver has committed a driving infraction based on data from the one or more sensors;
estimating, based on the speed and the driver has committed a driving infraction, a probability that the vehicle is the target vehicle of the emergency vehicle; and
transmitting a target vehicle alert to the vehicle indicating the probability that the vehicle is the target vehicle.

16. The method of claim 13, determining a destination of the emergency vehicle comprises:
receiving a message from the emergency vehicle indicating the target or destination of the emergency vehicle; and
determining the destination of the emergency vehicle from the message.

17. A vehicle including a system for guiding driver behavior based on an identified approaching emergency vehicle, the vehicle comprising:
one or more sensors configured to capture or receive data indicating that an emergency vehicle is approaching the vehicle;
an electronic control unit (ECU) in communication with the vehicle and the one or more sensors, and configured to:
determine an emergency vehicle is approaching the vehicle based on data captured or received from the one or more sensors;
determine a destination of the emergency vehicle;
determine a proposed response to aid the emergency vehicle; and
trigger the vehicle to perform the proposed response to aid the emergency vehicle.

18. The vehicle of claim 17, wherein the ECU is further configured to transmit a signal to surrounding vehicles to trigger the surrounding vehicles to perform the proposed response to aid the emergency vehicle.

19. The vehicle of claim 18, wherein the signal can trigger the vehicle to platoon with the surrounding vehicles and become operated by a single automated driving system to pull over to the side of the road in a coordinated manner to allow the emergency vehicle to pass.

20. The vehicle of claim 17, wherein the proposed response to aid the emergency vehicle comprises one or more of: parking over a pothole, ice patch, oil slick, or other hazard and flashing the vehicle's blinkers; parking and airing the vehicle exhaust toward an ice patch or snow to try to melt it; running over roadkill or debris to flatten it; pushing roadkill or debris to the side of the road; blocking crosswalks or perimeters of intersections to prevent pedestrians, bicyclists, or other vehicles, from entering the intersection; parking and shining the vehicle's headlights to illuminate hard-to-see areas; or lining the outside shoulder of a curve so that if the emergency vehicle slides or tips over, the vehicle knocks the emergency vehicle back into the roadway.
